(19) United States
(12) Patent Application Publication
(10) Pub. No.: US 2016/0012405 A1
(43) Pub. Date: Jan. 14, 2016

(54) METHOD AND SYSTEM OF PROCESSING A TRANSACTION FOR A GROUP

(71) Applicant: MasterCard International Incorporated, Purchase, NY (US)

(72) Inventor: Richard LYNCH, Co. Limerick (IE)

(73) Assignee: MasterCard International Incorporated, Purchase, NY (US)

(21) Appl. No.: 14/796,474

(22) Filed: Jul. 10, 2015

(30) Foreign Application Priority Data
Jul. 11, 2014 (GB) 1412367.3

(51) Int. Cl. G06Q 20/22; G06Q 20/20; G06Q 20/34

(52) U.S. Cl. CPC G06Q 20/22; G06Q 20/351; G06Q 20/20

(57) ABSTRACT

A method and system are provided for processing a transaction for a group of individuals. The method being performed at a network node and comprising operating a processor to provide an electronic point of sale group payment node having a plurality of virtual payment instruments associated thereto. A value is assigned to each of the virtual payment instruments. A destination account is associated with the EPOS group payment node. Individuals are associated with the respective virtual payment instruments by linking source accounts of the individuals to the virtual payment instruments. The transaction is complete such that the destination account receives a value based on the respective values assigned to the virtual payment instruments.

### FIELD OF THE INVENTION

The present disclosure relates to a method and system for processing a transaction for a group.

### BACKGROUND OF THE DISCLOSURE

It is often desirable for a group of people to purchase goods or services together. Typically, one of the group members pays a bill for the goods or services using their credit card and is then faced with task of collecting funds from the other members of the group. This approach is undesirable as it can lead to incorrect division of the bill between the group members. Also the person who makes the initial payment may incur charges on their account while waiting for the other members of the group to make payment. This is undesirable.

There is therefore a need for a method and system of processing a transaction for a group which addresses at least some of the drawbacks of the prior art.

### SUMMARY OF THE DISCLOSURE

In accordance with an aspect of the present invention, there is provided a computer-implemented method of processing a transaction for a group of individuals, the method being performed at a network node and comprising operating a processor to:

providing an electronic point of sale (EPOS) group payment node having a plurality of virtual payment instruments associated thereto;

assigning a value to each of the virtual payment instruments;

associating a destination account with the EPOS group payment node;

associating individuals to the respective virtual payment instruments by linking source accounts of the individuals to the virtual payment instruments; and

completing the transaction so that the destination account receives a value based on the respective values assigned to the virtual payment instruments. In one embodiment, two or more of the virtual payment instruments are assigned a different value to each other.

In another embodiment, the respective virtual payment instruments are independently configurable.

In a further embodiment, each virtual payment instrument is assigned a corresponding inventory.

In one exemplary arrangement, the EPOS group payment node is active for a set time period. Advantageously, the EPOS group payment node enters a locked mode after a defined time period which limits user accessibility.

In one embodiment, the virtual payment instruments are configurable for controlling access thereto. Advantageously, the virtual payment instruments are configurable so that data associated with the respective virtual payment instruments is concealed from the other virtual payment instruments.

In another exemplary arrangement, one of the virtual payment instruments is a master while the other virtual payment instruments are slaves under the control of the master.

In one embodiment, invitations are communicated to individuals inviting individuals to be associated with the virtual payment instruments. Advantageously, the invitations are communicated via a social network.

In another embodiment, the EPOS group payment node is configurable for adding additional virtual payment instruments. Advantageously, the EPOS group payment node is configurable for disassociating individuals from the virtual payment instruments.

In a further embodiment a notification is communicated to a device of each of the individuals associated with the virtual payment instruments providing a status of the transaction. Advantageously, the notification is communicated using a messaging platform. In one exemplary embodiment the notification includes a uniform resource locator which points to an address of the EPOS group payment node.

In one embodiment the EPOS group payment node provides a graphical user interface for facilitating user interaction. Advantageously, the respective virtual payment instruments have associated icon elements for facilitating user interaction.

In accordance with an embodiment of the disclosure, there is provided a system for processing a transaction for a group of individuals, the system comprising one or more modules which are configured to:

providing an electronic point of sale (EPOS) group payment node having a plurality of virtual payment instruments associated thereto, assigning a value to the respective virtual payment instruments;

associating a destination account with the EPOS group payment node;

associating individuals to the respective virtual payment instruments by linking source accounts of the individuals to the virtual payment instruments, and

completing the transaction so that the destination account receives a value based on the respective values assigned to the virtual payment instruments.

In accordance with another embodiment of the disclosure, a non-transitory computer-readable medium is provided comprising instructions which, when executed, cause a processor operating a network node to implement the method of processing a transaction for a group of individuals, the method comprising:

providing an electronic point of sale (EPOS) group payment node having a plurality of virtual payment instruments associated thereto,

assigning a value to the respective virtual payment instruments,

associating a destination account with the EPOS group payment node,

associating individuals to the respective virtual payment instruments by linking source accounts of the individuals to the virtual payment instruments, and

completing the transaction so that the destination account receives a value based on the respective values assigned to the virtual payment instruments.

### BRIEF DESCRIPTION OF THE DRAWINGS

Embodiments of the present invention will now be described, by way of example only, with reference to the accompanying drawings, in which:

FIG. 1 is a diagram of an electronic point of sale group (EPOS) payment node in accordance with the present teaching;

FIG. 2 is a flow diagram depicting an exemplary method of registering a group of individuals to the EPOS group payment node of FIG. 1;

FIG. 3 is a flow diagram depicting a method of processing a payment using the EPOS group payment node of FIG. 1; and

FIG. 4 is a diagram of another EPOS group payment node which is also in accordance with the present teaching.

### DESCRIPTION OF THE PREFERRED EMBODIMENT

Embodiments of the present invention will now be described with reference to an exemplary system for processing a transaction. It will be understood that the exemplary system is provided to assist in an understanding of the present teaching and is not to be construed as limiting in any fashion. Furthermore, modules or elements that are described with reference to any one Figure may be interchanged with those of other Figures or other equivalent elements without departing from the spirit of the present teaching.

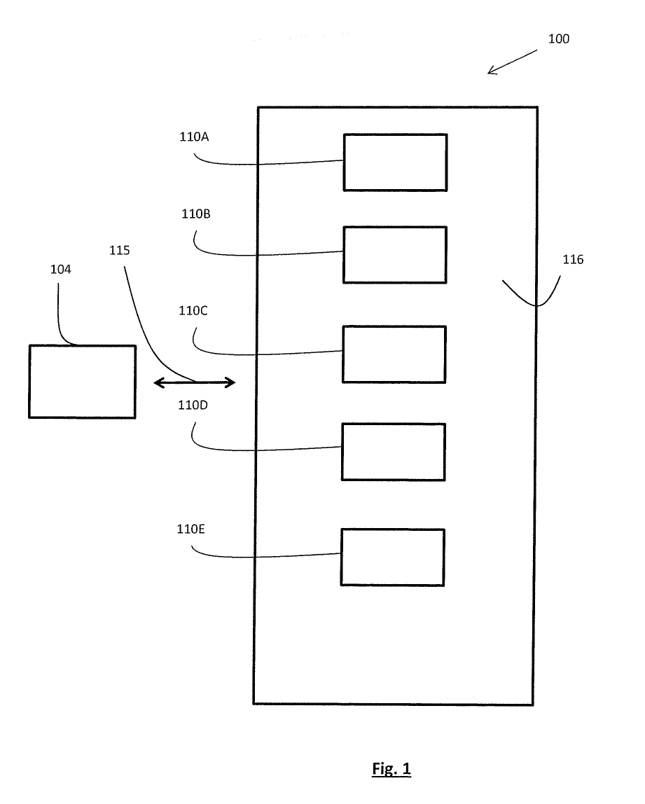

Referring to the drawings and, in particular to FIG. 1, an exemplary group payment system or group payment scheme 100 for processing a transaction for a group of individuals is shown. The system 100 facilitates a purchase (or transaction) using an on-line platform to be funded from a plurality of source accounts. In this manner, a group of individuals can arrange for a payment to be part-paid by (i.e. split between) the members of the group in a specified manner.

It will be appreciated that in the following, the term account is intended to include bank accounts, credit accounts, deposit accounts, checking accounts and the like. As will be described in more detail below, a group payment is a payment made to a merchant wherein the payment is ‘split up’ or divided in advance of the purchase so that it is paid using funds from the accounts of the group of individuals. The term virtual payment instrument refers to a software application that allows an individual to make an electronic transaction. A virtual instrument may be used to purchase items on-line using a smartphone or a computer. A virtual payment instrument may be a payment token associated with, or in, a virtual wallet, for example.

As discussed in more detail below, the system 100 comprises an electronic point of sale (EPOS) group payment node 104 that has a plurality of virtual payment instruments 110A-110E associated thereto. The payment instruments 110A-110E are accessible via computing device such as a smart phone 116. The EPOS group payment node 104 is configured to process a payment which is funded by a group of individuals. In this way the EPOS group payment node 104 is operated by a merchant and is operable to facilitate a group of individuals to make a group payment to the merchant in exchange for goods or services. The EPOS group payment node 104 may be an ‘acquirer network node’ associated with (linked to, operated on behalf of, comprised within a system of etc.) a financial institution that processes (or facilitates) card payments made to a merchant. Additionally or alternatively, the EPOS group payment node 104 may be one or more of a network node associated with (linked to, operated on behalf of, comprised within a system of etc.) a card issuer (or provider) and a card payment network node associated with a third party operating as, or in association with, a group payment provider. In the exemplary embodiment the EPOS group payment node 104 is provided on a network 115 of a merchant so that the group of individuals may purchase goods and/or services from the merchant via the EPOS group payment node 104. The network 115 may comprise any network across which communications can be transmitted and received. For example, the network 115 may comprise a wired or wireless network. The network 115 may, for example, comprise one or more of: the Internet; a local area network; a mobile or cellular network; a mobile data network or any other suitable type of network.

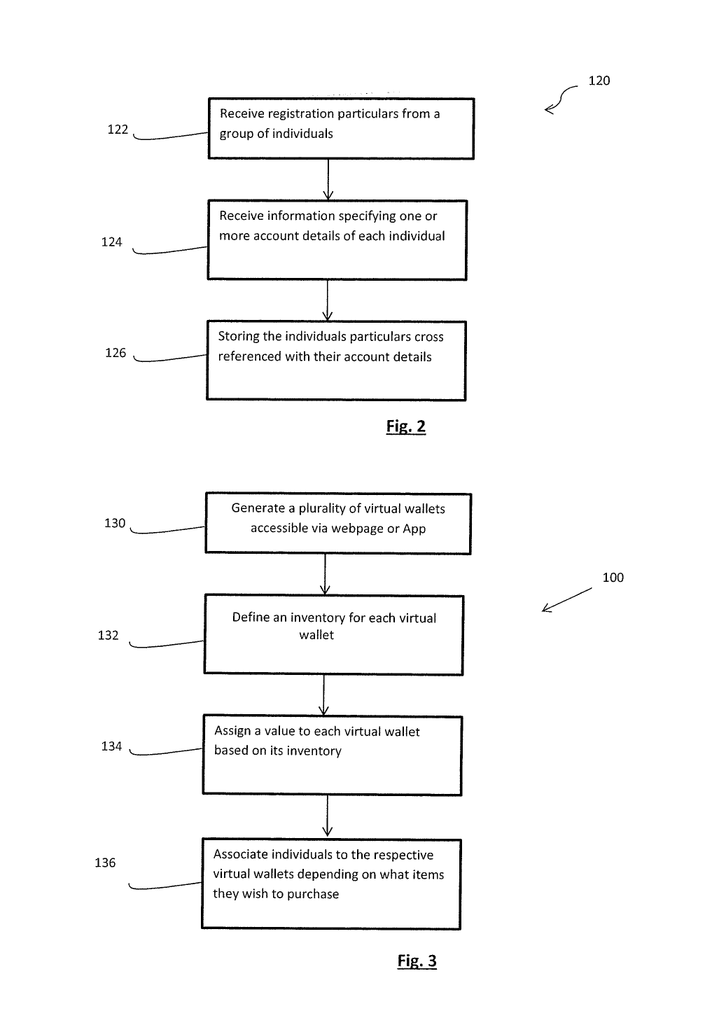

Prior to using the system 100, two or more individuals (i.e. a ‘group’ of individuals) wishing to make one or more group payments register to use the system 100. FIG. 2 depicts an exemplary method 120 of registering a group of individuals to use the system 100. The registration process 120 may be performed via the EPOS group payment node 104. Additionally or alternatively, the registration process may be performed (or part-performed) via one or more other nodes in a payment network. For example, the registration process may be performed by a card issuer, an acquirer or a third party operating in association with a group payment provider provided the individuals provide advance authorisation. Third parties may only register individuals to use the system 100 if the individuals have authorised the third party to do so and have supplied the necessary registration information to the third party in advance.

At block 122, the EPOS group payment node 104 receives details of a group of individuals wishing to use the group payment system 100. The details are received via a registration interface (not shown) which may be provided in any suitable manner. For example, the registration interface may be provided online via a provider website (not shown), via a telephone service, in person, mobile phone application, etc. In some embodiments, individuals may register to use the group payment system 100 at a point of sale, in which case the registration interface may be provided by a merchant terminal (not shown).

It will be appreciated that members of a group may provide registration information via the same interface and/or at the same time, e.g. during a single registration ‘session’ where each of the group members provides his/her respective details in turn before completion of the registration. Additionally or alternatively, one or more members of the group may provide his/her respective details at a different time and/or using a different registration interface. In this case, the EPOS group payment node 104 may subsequently link the registration information provided by the respective group members.

The details received at block 122 comprise at least the information necessary to authorize a payment from the respective accounts of the group members. In particular, the details received in respect of each of the account comprise a primary account number (PAN). Optionally, block 122 may receive additional information, for example, the account holder's name and/or date of birth; a sort code, the expiry date of a card associated with account; the issue date of the card; the cardholder's address; the credit card verification (CCV) number of the card; and a response to a security question.

At block 124, the group payment node 104 receives information specifying one or more account numbers associated with the individuals who registered in step 122, wherein the specified accounts provided are authorized by each of the group members to initiate payments that will be funded by the group. At block 126, the group payment node 104 stores the individual's particulars cross referenced with their account details so that the group payment node 104 has sufficient information to complete a group payment transaction.

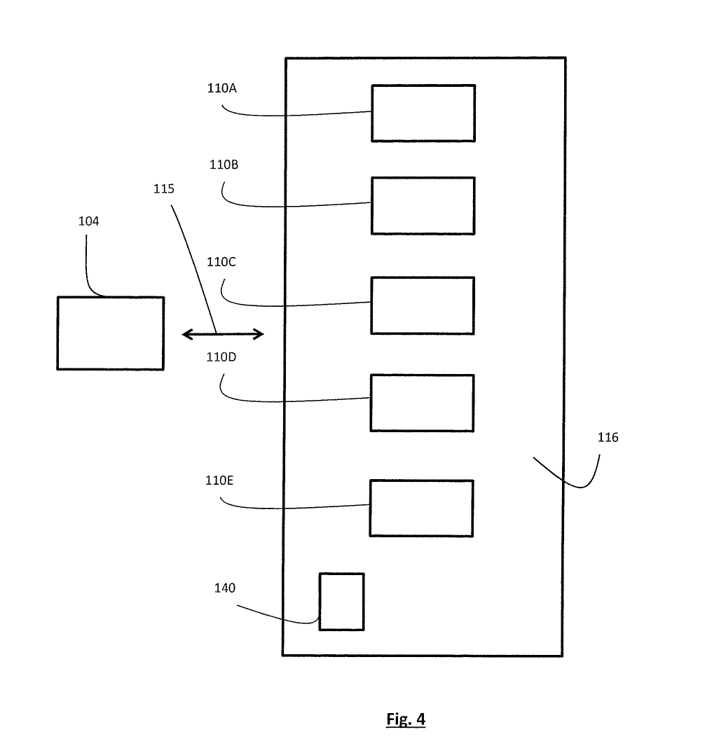

FIG. 3 depicts exemplary steps performed by the EPOS group payment node 104 during its configuration. At block 130, a plurality of virtual payment instruments are generated and made accessible via a webpage or mobile phone application. At block 132, an inventory is defined for each virtual payment instrument. The inventory may include a list of good or services that the individuals of the group may wish to purchase. The value of each generated virtual payment instrument is set at block 134 and depends on the list of goods/services associated with the virtual payment instrument in block 132. The value may be a monetary value required to pay for the inventory listed in the virtual payment instrument. At block 136, members that registered with the EPOS group payment node 104 are associated with the respective virtual payment instruments. The group member may request to be added to a particular payment instrument based on the inventory associated with that virtual payment instrument. The value of each payment instrument is displayed with the inventory and when the member selects a particular payment instrument they agree to have the value corresponding to the value of the virtual payment instrument to be deducted from their account. The EPOS group payment node 104 has a destination account linked thereto so that when the transaction is being completed the destination account receives a credit transfer from the member accounts associated with the virtual payment instruments.

The EPOS group payment node 104 provides the ability to collect one payment, comprising of multiple payments, where those multiple payments comprise of varying amounts but some of the payment may have a common value. The merchant providing the goods/services for sale creates the EPOS group payment node via the webpage or app. A plurality of virtual payment instruments 110A-110E are created for each payment amount, for example, [symbol] 120, [symbol] 130, [symbol] 140, [symbol] 150, [symbol] 160. The merchant invites the individuals to the appropriate virtual payment instrument depending on the goods or services which they require. When all virtual payment instruments have been associated with the members then the collective payment is sent as one to the merchant or as multiple individual payments. The merchant receives what they are owed in from each person. Alternatively, the merchant receives an aggregated amount through a third party platform. The EPOS group payment node 104 is particularly useful where a booking is based on several individuals but each individual pays a different amount but the booking needs to be created as one. For example, when booking a ski holiday through a tour operator, typically, individuals of the ski group require different items to satisfy their individual needs. For example, two people may need ski lessons, three people may need lessons and ski rental; and five people may need ski passes. The tour operator creates a virtual payment instrument for each category listing the inventory of each category and attaches the members, who then add their account details and are billed accordingly.

It will be understood by those skilled in the art that the present disclosure relates to a computer-implemented method of processing a transaction for a group of individuals. The method provides an EPOS group payment node 104 having a plurality of virtual payment instruments 110A-110E. The method is performed at a network node which includes a processor to perform the method steps. The EPOS group payment node 104 is typically provided on a merchant's network who is selling goods and/or services. A destination account is linked to the EPOS group payment node to which funds are transferred when the group payment transaction is completed. Each virtual payment instrument 110A-110E is assigned a value based on the inventory (goods/services) of the virtual payment instrument. Individuals which are registered with the EPOS group payment node 104 are linked to the respective virtual payment instruments 110A-110E depending on the goods/services which they require. In this way account details of the individuals are associated with the virtual payment instrument which they are assigned to. The EPOS group payment node 104 completes the transaction by communicating with the accounts that are associated with the respective virtual payment instruments so that the destination account is credited with a value which is based on the respective values assigned to the virtual payment instruments.

The EPOS group payment node 104 has a graphical user interface which allows the respective virtual payment instruments to be independently configurable. It is desirable to encourage members to register in a timely manner. Thus the EPOS group payment node 104 can be set to be active for a set time period. When the set time period expires the EPOS group node payment node 104 becomes inactive. In an exemplary arrangement, the EPOS group payment node may enter a locked mode after a defined time period which limits user accessibility to the virtual payment instruments 110A-110E. In the interest of data protection the virtual payment instruments may be configurable for controlling access thereto. In this way, the virtual payment instruments may be configured so that data of individuals associated with the respective virtual payment instruments are concealed from other members of the group. In some circumstances, it is desirable to make one of the virtual payment instruments a master while the other virtual instruments are slaves under the control of the master. In the context of the ski holiday example, the master may be associated with the individual who organises the ski trip. The master may define the inventory for each virtual payment instrument 110A-110E and/or the value of each payment instrument. The EPOS group payment node 104 may include a communication module 140 as illustrated in FIG. 4 which is operable to communicate invitations via a messaging platform inviting individuals to be associated with the virtual payment instruments. The messaging platform may be a text or media message service such as short message service (SMS). The communication module 140 may be communicable with a social network for facilitating forwarding the invitations. The EPOS group payment node 104 is configurable for adding additional virtual payment instruments. Furthermore, the group payment node is configurable for disassociating individuals from the virtual payment instruments.

The communication module 140 may provide a notification to a device of each of the group members associated with the virtual payment instruments 110A-110E providing a status of the transaction. The status may indicate the amount of time left before the EPOS group payment node 104 expires. The status may also indicate that the transaction was been successfully completed. Alternatively, the status may indicate that the transaction failed because some of the accounts associated with the virtual payment instruments 110A-110E had insufficient funds. The notification may include a uniform resource locator which points to an address of the EPOS group payment node 104. The EPOS group payment node 104 may be visually represented using a graphical user interface (GUI) for facilitating user interaction via a website or the like. The respective virtual payment instrument 110A-110E have associated icon elements which may be displayed on a display of a computing device such as a smartphone, a tablet computer, a laptop, a personal digital assistant, etc. Individuals may interface with the virtual payment instruments (110A-110E) using computing devices.

It will be appreciated that the processor which controls the operations of the EPOS group payment node may include one or more software modules which are programmed to implement predefined functions. For example, a first software module may be provided for generating the group payment node 104 so that it has a plurality of virtual payment instruments 110A-110E associated with it. A second software module may be configured for assigning a value to the respective virtual payment instruments 110A-110E. A third software module may be configured to associate a destination account with the EPOS group payment node 104 so that funds from the accounts of the individuals are credited to the destination account. A fourth software module may be configured for associating individuals to the respective virtual payment instrument 110A-110E by linking the accounts of the individuals to the virtual payment instruments. A fifth software module may be configured for completing the transaction so that the destination account is credited with a value based on the values assigned to the respective virtual payment instruments 110A-110E. While five software modules have been described for controlling the operations of the processor, it is not intended to limit to present teaching to a specific number of software modules. It will be appreciated by those skilled in the art that the one or more software modules may be programmed to complete the transaction.

It will be understood that what has been described herein is a system 100 for processing a transaction. While the present disclosure has been described with reference to exemplary arrangements it will be understood that it is not intended to limit the disclosure to such arrangements as modifications can be made without departing from the spirit and scope of the present teaching. The method of the present teaching may be implemented in software, firmware, hardware, or a combination thereof. In one mode, the method is implemented in software, as an executable program, and is executed by one or more special or general purpose digital computer(s). The steps of the method may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the first, second, third, fourth and fifth software modules as described above. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions.

Memory is associated with processor(s) and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present disclosure may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the process, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiment(s) without substantially departing from the spirit and principles of the present teaching. All such modifications are intended to be included herein within the scope of this disclosure and the present invention and protected by the following claims. For example, steps associated with the processes described herein can be performed in any order, unless otherwise specified or dictated by the steps themselves. The present disclosure is intended to embrace all such alternatives, modifications and variances that fall within the scope of the appended claims.

It will be appreciated that the system 100 may be implemented using cloud or local server architecture. In this way it will be understood that the present teaching is to be limited only insofar as is deemed necessary in the light of the appended claims.

Similarly the words comprises/comprising when used in the specification are used to specify the presence of stated features, integers, steps or components but do not preclude the presence or addition of one or more additional features, integers, steps, components or groups thereof.

What is claimed is:

1. A computer-implemented method of processing a transaction for a group of individuals, the method being performed at a network node and comprising operating a processor to:
providing an electronic point of sale (EPOS) group payment node having a plurality of virtual payment instruments associated thereto,
assigning a value to each of the virtual payment instruments;
associating a destination account with the EPOS group payment node;
associating individuals to the respective virtual payment instruments by linking source accounts of the individuals to the virtual payment instruments, and
completing the transaction so that the destination account receives a value based on the respective values assigned to the virtual payment instruments.

2. A method as claimed in claim 1 wherein two or more of the virtual payment instrument are assigned a different value to each other.

3. A method as claimed in claim 1, wherein the respective virtual payment instruments are independently configurable.

4. A method as claimed in claim 3, wherein each virtual payment instrument is assigned a corresponding inventory.

5. A method as claimed in claim 1, wherein the EPOS group payment node is active for a set time period.

6. A method as claimed in claim 1, wherein the EPOS group payment node enters a locked mode after a defined time period which limits user accessibility.

7. A method as claimed in claim 1, wherein the virtual payment instruments are configurable for controlling access thereto.

8. A method as claimed in claim 7, wherein the virtual payment instruments are configurable so that data associated with the respective virtual payment instruments is concealed from the other virtual payment instruments.

9. A method as claimed in claim 1, wherein one of the virtual payment instruments is a master while the other virtual payment instruments are slaves under the control of the master.

10 A method as claimed in claim 1, wherein invitations are communicated to individuals inviting individuals to be associated with the virtual payment instruments.

11. A method as claimed in claim 10, wherein the invitations are communicated via a social network.

12. A method as claimed in claim 1, wherein the EPOS group payment node is configurable for adding additional virtual payment instruments.

13. A method as claimed in claim 1, wherein the EPOS group payment node is configurable for disassociating individuals from the virtual payment instruments.

14. A method as claimed in claim 1, wherein a notification is communicated to a device of each of the individuals associated with the virtual payment instruments providing a status of the transaction.

15. A method as claimed in claim 14 wherein the notification is communicated using a messaging platform.

16. A method as claimed in claim 14, wherein the notification includes a uniform resource locator which points to an address of the EPOS group payment node.

17. A method as claimed in claim 1, wherein the EPOS group payment node provides a graphical user interface for facilitating user interaction.

18. A method as claimed in claim 17, wherein the respective virtual payment instruments have associated icon elements for facilitating user interaction.

19. A non-transitory computer-readable medium comprising instructions which, when executed, cause a processor operating a network node to implement the method as claimed in claim 1.

20. A system for processing a transaction for a group of individuals, the system comprising one or more modules which are configured to
providing an electronic point of sale (EPOS) group payment node having a plurality of virtual payment instruments associated thereto;
assigning a value to the respective virtual payment instruments;
associating a destination account with the EPOS group payment node;
associating individuals to the respective virtual payment instruments by linking the accounts of the individuals to the virtual payment instruments, and
completing the transaction so that the destination account receives a value based on the respective values assigned to the virtual payment instruments.
